(19) United States
(12) Patent Application Publication
(10) Pub. No.: US 2007/0075692 A1
(43) Pub. Date: Apr. 5, 2007

(54) METHODS AND APPARATUS FOR CURRENT-CONTROLLED TRANSIENT REGULATION

(76) Inventors: Kenneth R. Ostrom, Palos Verdes, CA (US); Benjamin Tang, Rancho Palos Verdes, CA (US); Tim M. Ng, Monterey Park, CA (US); Clifford N. Duong, Fountain Valley, CA (US)

Correspondence Address: NOBLITT & GILMORE, LLC., 4800 NORTH SCOTTSDALE ROAD, SUITE 6000, SCOTTSDALE, AZ, 85251, US

(21) Appl. No.: 11/538,218

(22) Filed: Oct. 3, 2006

Related U.S. Application Data
(63) Continuation-in-part of application No. 09/945,187, filed on Aug. 31, 2001.
(60) Provisional application No. 60/723,370, filed on Oct. 3, 2005.

(51) Int. Cl. G05F 1/00

(52) U.S. Cl. 323/274

(57) ABSTRACT

Methods and apparatus for regulating power supply according to various aspects of the present invention operate in conjunction with an electronic system configured to interface with a primary voltage regulator. The electronic system comprises a load configured to receive supply current from the primary voltage regulator and a secondary voltage regulator. The secondary voltage regulator includes at least one current source coupled to the load and is configured to provide current to the load. The secondary voltage regulator further comprises a control circuit coupled to the current source and the load, which determines a current demand for the load exceeding the supply current received from the primary voltage regulator, and adjusts the current provided to the load by the current source according to the current demand.

### CROSS-REFERENCES TO RELATED APPLICATIONS

The present application claims the benefit of U.S. Provisional Patent Application 60/723,370, filed Oct. 3, 2005, entitled “Current Controlled Transient Regulator and Method of Using”, and is a continuation in part of U.S. Nonprovisional Application Serial No. 09/945,187, entitled, “Apparatus and System for Providing Transient Suppression Power Regulation”, filed on Aug. 31, 2001, and assigned to the assignee of the present application.

### BACKGROUND OF THE INVENTION

Power regulation for a microelectronic device such as a microprocessor must include a steady voltage and an ability to respond to dynamic current demands of the processor.

For example, as a microprocessor executes instructions, particularly at faster rates, severe power transients are likely to occur. These severe current transients, if not properly regulated, can cause noise on the power supply that can induce errors in the microprocessor.

Typical power regulation systems include a collection of decoupling capacitors that are placed across the load between the power supply and ground, in combination with a voltage regulator. On-chip decoupling techniques, e.g., decoupling capacitors integrated on the die, generally require a relatively large chip area, store a relatively small charge compared to the transient load demands of the microprocessor, and tend to reduce reliability of the microprocessor.

Typical off-chip decoupling generally has limited effectiveness because of the parasitic inductance in the power supply leads. In addition, off-chip as well as on-chip active voltage regulation employing conventional circuit design approaches generally lack the bandwidth to respond to fast load transients. Further, typical off-chip regulation approaches generally have limited bandwidth and effectiveness in responding to the transients because of the parasitic inductance between the regulation source and the load.

### SUMMARY OF THE INVENTION

Methods and apparatus for regulating a power supply according to various aspects of the present invention operate in conjunction with an electronic system configured to interface with a primary voltage regulator. The electronic system comprises a load configured to receive supply current from the primary voltage regulator and a secondary voltage regulator. The secondary voltage regulator includes at least one current source coupled to the load and is configured to provide current to the load. The secondary voltage regulator further comprises a control circuit coupled to the current source and the load, which determines a current demand for the load exceeding the supply current received from the primary voltage regulator, and adjusts the current provided to the load by the current source according to the current demand.

### BRIEF DESCRIPTION OF DRAWING FIGURES

A more complete understanding of the present invention may be derived by referring to the detailed description and claims when considered in connection with the figures, where like reference numbers refer to similar elements throughout the figures, and:

FIG. 1 illustrates a block diagram of an exemplary current controlled transient regulator circuit in accordance with various aspects of the present invention;

FIG. 2 illustrates a transfer function of the embodiment of FIG. 1;

FIG. 3 illustrates a frequency response of an exemplary current controlled transient regulator circuit in accordance with the present invention;

FIG. 4 illustrates an exemplary current response of a current controlled transient regulator;

FIG. 5 is a top plan view of a microprocessor package that includes a current controlled regulator according to an embodiment;

FIG. 6 is a bottom plan view of a microprocessor package that includes a current controlled regulator according to an embodiment;

FIG. 7 is a top plan view of a microprocessor package that includes a current controlled regulator according to an alternate embodiment;

FIG. 8 is a bottom plan view of a microprocessor package that includes a current controlled regulator according to an alternate embodiment;

FIG. 9 is a top plan view of a microprocessor package that includes a current controlled regulator and a die-side capacitor according to an embodiment;

FIG. 10 is a bottom plan view of a microprocessor package that includes a current controlled regulator and a die-side capacitor according to an embodiment;

FIG. 11 is a top plan view of a microprocessor package that includes a current controlled regulator and a bottom-side capacitor according to an embodiment;

FIG. 12 is a bottom plan view of a microprocessor package that includes a current controlled regulator and a bottom-side capacitor according to an embodiment; and

FIG. 13 is a flow diagram of a method for controlling transients.

### DETAILED DESCRIPTION OF EXEMPLARY EMBODIMENTS

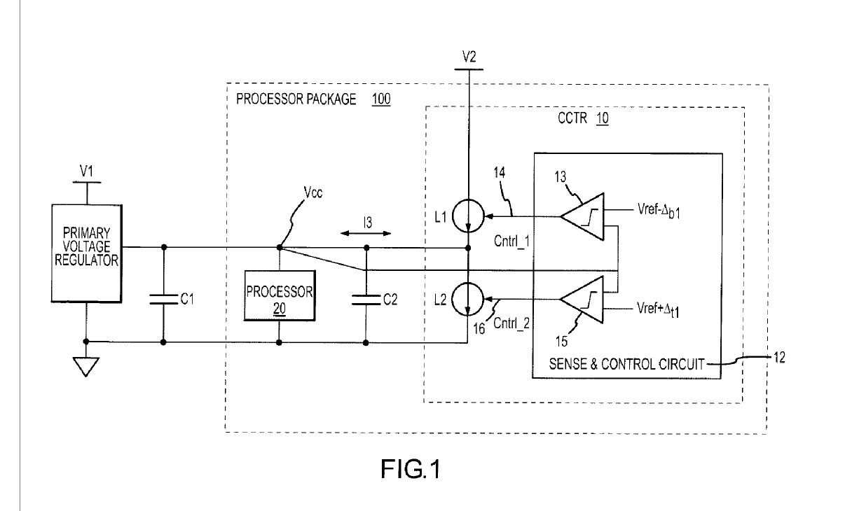

Referring now to FIG. 1, an electronic system according to various aspects of the present invention comprises a load 20 configured to receive power from a primary voltage regulator 22 and a secondary voltage regulator 10. The primary voltage regulator 22 provides the main voltage supply to the load 20. The secondary voltage regulator 10 regulates dynamic undervoltage and/or overvoltage conditions that are beyond the regulation capability of the primary voltage regulator 22. The electronic system may further include one or more passive supply elements to provide further voltage regulation, such as a pair of bypass capacitors.

The load 20 receives a supply current from the primary voltage regulator 22 and secondary voltage regulator 10, and may comprise any system that consumes electrical current, such as a microprocessor-based device or an integrated circuit device. The load 20 may comprise a dynamic load, which varies its power consumption over time.

The load 20 is configured for receiving a regulated supply current via an output voltage V_{cc}, as regulated and provided from the primary voltage regulator 22 and the secondary voltage regulator 10. In the present embodiment, the load 20 comprises internal circuitry, with an activity level that varies depending on the function the internal circuitry is performing at any given time, resulting in increases and decreases in load current demanded.

The primary voltage regulator 22 provides a regulated output voltage to the load 20. The primary voltage regulator 22 may comprise any appropriate supply, such as a conventional regulated voltage supply. In the present embodiment, the primary voltage regulator 22 comprises a voltage regulator configured within a linear loop to facilitate a well-controlled, regulated output voltage V_{cc} approximating a target voltage, such as 1.5 or 1.8 volts. In particular, the present primary voltage regulator 22 may comprise a switching regulator for high efficiency or a non-switching regulator with less efficiency, and is configured to operate from a supply voltage V1, such as a 12-volt supply. The primary voltage regulator 22 may interface with the load 20 in any manner, such as via conventional connections that may generate parasitic inductances (not shown).

The primary voltage regulator 22 may be configured to drive the output voltage V_{cc} to the target voltage V_{REF}. The difference between output voltage V_{cc}, and the target voltage comprises an error voltage V_{ERROR}, i.e., V_{cc}−V_{REF}=V_{ERROR}. The primary voltage regulator 22 may be configured to regulate the error voltage V_{ERROR} to approximately zero volts in a linear manner, such that the response of primary voltage regulator 22 is proportional to the error voltage V_{ERROR}. The primary voltage regulator 22 may exhibit a slow response, such as about 100 ns to 10 microseconds.

In addition, the bandwidth of the primary voltage regulator 22 may be limited, such as to maintain stable operation of the linear loop in the presence of the parasitic inductances. In the present embodiment, the bandwidth of the primary voltage regulator 22 is limited to approximately 100 kHz to 2 MHz, though the range of values may be selected according to the configuration of the electronic system or any other suitable criteria. The primary voltage regulator 22 may be configured for normal regulation within the linear loop, i.e., for addressing small changes in the output voltage, such as smaller error voltages V_{ERROR} within selected undervoltage and/or overvoltage threshold levels.

The supplementary supply provides additional current to the load 20 when needed, for example to sustain the output voltage V_{cc} required by the load 20 and provide additional time for the primary voltage regulator 22 to accommodate the power demand changes at the dynamic load 20 during normal regulation. The supplementary supply may also be configured to filter dynamic switching currents, such as currents caused by parasitic inductances. The supplementary supply may comprise any suitable supply, such as one or more batteries or capacitors. In the present embodiment, the supplementary supply comprises a passive supply, such as a first bypass capacitor C1 and a second bypass capacitor C2 coupled across the load 20. The bypass capacitors C1, C2 provide decoupling capacitances across the load 20. The bypass capacitors C1, C2 may be configured to filter dynamic switching currents of the primary regulator 22 and provide dynamic charge to the load 20 with a response time of approximately I microsecond.

The secondary voltage regulator 10 provides improved regulation of the supply current for the dynamic load 20 by adjusting the current provided to the load 20, for example by providing a positive current (i.e., providing additional current) or a negative current (i.e., draining excess current). The secondary voltage regulator 10 may be configured in any manner to adjust the voltage applied to the load 20 according to the demand of the load 20 and/or the current provided by other sources. In the present embodiment, the secondary voltage regulator 10 is configured for regulating dynamic undervoltage and/or overvoltage conditions at the load 20 that are beyond the regulation capability of the primary voltage regulator 22 and the bypass capacitors C1, C2. For example, the secondary voltage regulator 10 may be configured within a wideband, non-linear loop for determining undervoltage and/or overvoltage conditions at the dynamic load 20. The secondary voltage regulator 10 may monitor changes in the output voltage V_{cc} to determine when the error voltage V_{ERROR} exceeds predetermined undervoltage and/or overvoltage threshold values, and adjust the current, positively or negatively, provided to the load 20 accordingly. The secondary voltage regulator 10 may include a plurality of secondary voltage regulator circuits, with each secondary voltage regulator circuit configured to identify undervoltage and/or overvoltage conditions and provide current to and/or sink current from the load 20 accordingly.

The response of the secondary voltage regulator 10 may be configured to control the magnitude of the error voltage V_{ERROR}. The secondary voltage regulator 10 may be configured with a nonlinear response, however, such that the response to the change in current demand is not linearly proportional to the error voltage V_{ERROR}. The nonlinear response tends to inhibit conflicting control efforts exerted by the primary voltage regulator 22 and the secondary voltage regulator 10. In addition, the secondary voltage regulator 10 may be configured with a fast response time to generate corrective action before the primary voltage regulator 22 reacts to the error voltage V_{ERROR}. For example, in the present embodiment, the secondary voltage regulator 10 is configured to have a wideband control loop with a response time between about 100 ps to 10 ns.

The secondary voltage regulator 10 may be configured in any appropriate manner to provide the secondary voltage regulation. For example, a secondary voltage regulator 10 according to various aspects of the present invention comprises a current-controlled transient regulator (CCTR) operating as a supplemental voltage regulator. The present CCTR is configured to determine the current demand of the load 20 by monitoring the output voltage V_{cc} and adjust the voltage towards the target voltage V_{REF} based on a nonlinear response. The present CCTR is also configured to provide a fast response to provide more immediate regulation than is available from the primary voltage regulator 22. In one exemplary embodiment, the CCTR comprises a control circuit 12 and at least one current source 11, 12. The current source provides a positive and/or negative current to the load 20. The control circuit 12 determines the current demanded by the load 20 that exceeds the supply current received from the primary voltage regulator t1 and/or other sources, and adjusts the current provided to the load 20 by the current source 11, 12 according to the current demand.

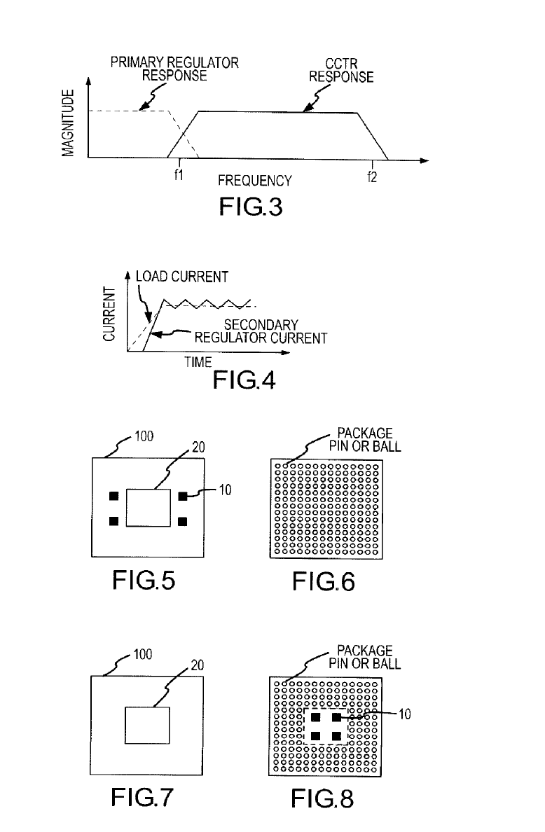

The CCTR may be configured to exhibit a selected frequency response, for example to complement the frequency response of the primary voltage regulator 22. Referring to FIG. 3, the primary voltage regulator 22 may have a range of frequency response, such as from DC (direct current) to approximately a selected frequency f1. The CCTR may have a frequency response beginning at approximately f1 and extending to frequency f2. By example, f1 is in the range of 100 kHz to 10 MHz and f2 is in the range of 100 MHz to 5 GHz. The frequency response of the CCTR may be effected by the control circuit 12 and/or the current source 11, 12. Thus, the secondary voltage regulator 10 may be configured to respond to a change in the current demand faster than the primary voltage regulator 22. Optimizing the response of the primary voltage regulator 22 in combination with the secondary voltage regulator 10 improves the transient response of the output voltage V_{cc} via the secondary voltage regulator 10 while preserving power delivery efficiency of the primary voltage regulator 22.

The control circuit 12 monitors the dynamic demand of the load 20 and adjusts the current provided to the load 20 by the current source 11, 12 according to the demand, such as the magnitude of the change in the demand. The control circuit 12 may be configured in appropriate manner to monitor the load 20 demand. For example, the control circuit 12 may be configured to compare the current demand as indicated by the output voltage V_{cc} to one or more threshold voltages. In the present embodiment, at least one comparator device can be configured for comparing changes in the output voltage V_{cc} to a predetermined undervoltage threshold or an overvoltage threshold. The control circuit 12 may then control the current source 11, 12 to provide a positive current to the load 20 for undervoltage conditions or a negative current for overvoltage conditions. In one embodiment, the CCTR may be configured with a single comparator device and a single current source for determining undervoltage or overvoltage conditions, and for sourcing current to or sinking current from the load 20.

For example, the present control circuit 12 comprises at least one comparator, such as a high speed device configured to compare at least two voltages and generate a corresponding output signal. In the present embodiment, the control circuit 12 comprises one or more comparator devices configured to compare the voltage provided to the load to threshold voltages. More particularly, the present control circuit 12 comprises an upper threshold comparator 15 and a lower threshold comparator 13. The lower threshold comparator 13 is configured to detect undervoltage conditions, i.e., the load voltage V_{cc} is less than the difference between the reference voltage V_{REF} and an undervoltage threshold Δ_{b1}. In one embodiment, the lower threshold comparator 13 has a positive input terminal coupled to an undervoltage condition signal, V_{REF}−Δ_{b1}, and a negative input terminal coupled to the load 20 in a voltage feedback arrangement to measure or sense the load voltage V_{cc} . The comparator connections may be coupled directly to other circuit elements by conductive material or indirectly coupled via other electronic components.

Likewise, the upper threshold comparator 15 is configured to detect overvoltage conditions, i.e., the load voltage V_{cc} is greater than the sum of the reference voltage V_{REF} and an overvoltage threshold Δₜ₁. In one embodiment, the upper threshold comparator 15 has a positive input terminal coupled to an overvoltage condition signal, V_{REF}−Δₜ₁, and a negative input terminal coupled to the load 20 in a voltage feedback arrangement to measure or sense load voltage V_{cc}.

The reference voltage V_{REF} may be generated in any appropriate manner, such as fixed at a voltage level, for example approximately 1.8 volts. In addition, the reference voltage V_{REF} can be provided as a readily configurable voltage derived from another voltage or current references. For example, reference voltage V_{REF} can comprise a filtered or representative voltage based on the average load current or average load voltage V_{cc} over some fixed or variable period of time.

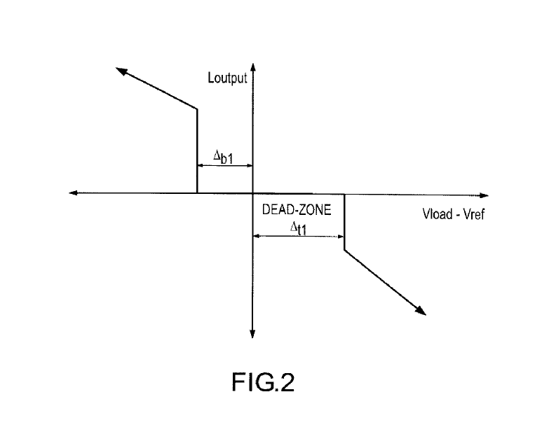

The thresholds may be selected according to any suitable criteria, and may be symmetrical with respect to the reference voltage V_{REF}. The undervoltage threshold Δ_{b1} and the overvoltage threshold Δₜ₁, can suitably be configured at various predetermined levels, such as between approximately 1 mV and hundreds of millivolts, depending on the desired operation of secondary voltage regulator 10. In addition, the undervoltage threshold Δ_{b1} may be selected to inhibit low voltage failures, such as logic failures, while the overvoltage threshold Δ_{b1}, me be selected to reduce power dissipation that can stress integrated circuitry within dynamic load 20. Thus, referring to FIG. 2, while the undervoltage threshold Δ_{b1} and the overvoltage threshold Δₜ₁, can be configured at the same levels with respect to the target voltage V_{REF}, the undervoltage threshold Δ_{b1}, and overvoltage threshold Δₜ₁, do not need to be symmetrical around the target voltage V_{REF}. For example, the undervoltage threshold Δ_{b1} can be configured at an approximately 30 mV level below the target voltage V_{REF}, while the overvoltage threshold Δₜ₁, can be configured at an approximately 100 mV level above the target voltage V_{REF}. Further, the levels of the undervoltage threshold Δ_{b1}, and overvoltage threshold Δₜ₁ may be varied for modifying the gain of the secondary voltage regulator 10. Accordingly, any of various levels can be implemented for the undervoltage threshold Δ_{b1}, and overvoltage threshold Δₜ₁, to provide desired operation.

The current source 11, 12 is coupled to the load 20, directly or indirectly, and provides positive or negative current to the load 20. The current source 11, 12 may be controlled by the control circuit 12. The current source 11, 12 may comprise any appropriate system for providing or drawing current to or from the load 20. In one embodiment, the current source 11, 12 regulates the output voltage V_{cc} The current delivered by the current source 11, 12 to the load 20 may be controlled in magnitude and/or duration and may approximately match the current demands of the load 20. Further, the current source 11, 12 may be configured to inhibit effects upon the impedance of the power delivery network at V_{cc} as well as to minimize or eliminate production of transient noise at the load 20.

For example, the present secondary voltage regulator 10 comprises at least two current sources 11, 12, such as a supply current source 11 and a drain current source 12. Each current source 11, 12 may be controlled by a comparator 13, 15, and may have a relatively high impedance, such as in the range of 10-100 ohms. In the present embodiment, the output of the lower threshold comparator 13 is coupled to the supply current source 11 to identify undervoltage conditions and provide additional current to the load 20. Likewise, the output of the upper threshold comparator 15 is coupled to the drain current source 12 to identify overvoltage conditions and drain excess current from the load 20. The supply current source 11 may be supplied current by a supply voltage V2, and the drain current source 12 may be coupled to ground. The current sources 11, 12 may be directly or indirectly coupled to the load 20 in any appropriate manner, such as via connection from a die pad or other connection mechanism, to allow a positive or negative current 13 to flow to or from the load 20 during the sourcing and sinking of current.

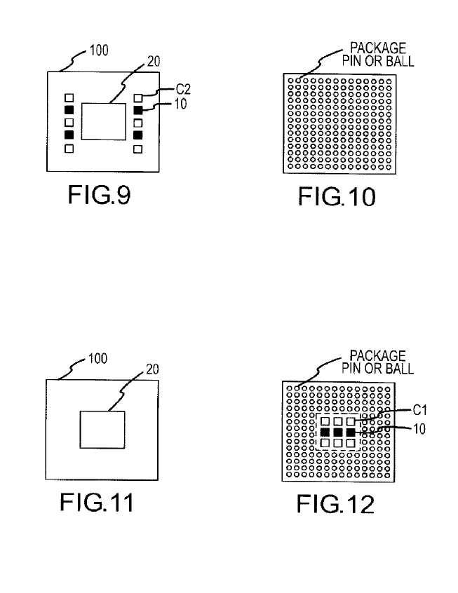

The load 20 and the secondary voltage regulator 10 may be configured to optimize voltage regulation. For example, the secondary voltage regulator 10 and the second bypass capacitor C2 may be physically located on the same package as the load 20, such as on the microprocessor package, and may be coupled to the load 20. Referring to FIGS. 5 and 6, the secondary voltage regulator to is part of the microprocessor package 100 and mounted adjacent to the microprocessor die. In another embodiment, referring to FIGS. 7 and 8, the secondary voltage regulator 10 is part of the microprocessor package 100 and located under the microprocessor die 20 or on the opposite side of the package relative to the microprocessor die 20. In another embodiment, referring to FIGS. 9 and 10, the secondary voltage regulator 10 and at least one bypass capacitor C2 are part of the microprocessor package and are mounted adjacent to the microprocessor die. In yet another embodiment, referring to FIGS. 11 and 12, the secondary voltage regulator 10 and at least one bypass capacitor C2 are part of the microprocessor package 100 and are located under the microprocessor die 20 or on the opposite side of the package relative to the microprocessor die 20. Further, the sense and control circuit 12 may be configured to sense the load demand at a location proximate to the microprocessor load 20.

The secondary voltage regulator 10 is configured to respond to dynamic changes in the load 20 current to minimize power supply voltage transients. For example, in one embodiment, the load 20 comprises a microprocessor, which operates in a range of 0.5V to 2V to and draws current in the range of 10 A to 100 A. As the current of the microprocessor load 20 increases, such as a ramp up or step up or other increase in current, for example from 1 A to 10 A, or from 10 A to 100 A, over a relatively short time period, for example from 1 ns to 100 ns, the sense and control circuit 12 identifies whether the output voltage drops below the lower threshold and controls the supply current source 11 connected between V₂ and V_{cc} to minimize the transient voltage change on V_{cc} at the microprocessor load 20.

Likewise, as the current demand of the microprocessor load 20 decreases, such as a ramp down or step down or other decrease in current, by example from 10 A to 1 A, or from 100 A to 10 A, over a relatively short time period, for example from 1 ns to 100 ns, the sense and control circuit 12 identifies whether the output voltage exceeds the upper threshold and controls the drain current source 12 connected between V_{cc} and ground to minimize the transient voltage change on V_{cc} at the microprocessor load 20. Referring to FIG. 2, the sense and control circuit 12 is configured such that when the supply current source 11 is on, the drain current source 12 is off or in a standby state. Conversely, when drain current source 12 is on, supply current source 11 is off or in a standby state. When no load 20 transients are detected, both current sources 11, 12 are off or in a standby state.

Thus, in the event of a predetermined change in the error voltage in the negative direction, the secondary voltage regulator 10 provides a positive current output. Similarly, upon a predetermined change in the error voltage in the positive direction (a change that is larger than the change in the negative direction in the present embodiment), the secondary voltage regulator 10 drains current from the load 20.

While the load voltage V_{cc} remains between the threshold voltages, the secondary voltage regulator 10 provides neither a positive nor a negative current to the load 20.

Further, the secondary voltage regulator 10 controlled current response approximately equals the dynamic current demands of the microprocessor load 20 that are beyond the response of the primary voltage regulator 22 and/or bypass capacitors Cl, C2. The secondary voltage regulator 10 reduces the dynamic charge required by the primary regulator 22 and capacitors C1, C2.

Referring to FIG. 4, the load 20 may undergo an increase in dynamic current demand, for example from 10 A to 50 A over a period of 10 ns. The secondary voltage regulator 10 provides dynamic current approximately matched to the demand of the load minus the dynamic current contributions of the passive decoupling capacitors C1, C2 and primary voltage regulator 22. Both the magnitude and time duration of the current output response of the secondary voltage regulator 10 may be precisely controlled by responses of the sense and control circuit and the current sources. As a result of the high gain for changes greater than the threshold levels, the wideband, nonlinear loop can quickly respond to fast changes in the dynamic load 20.

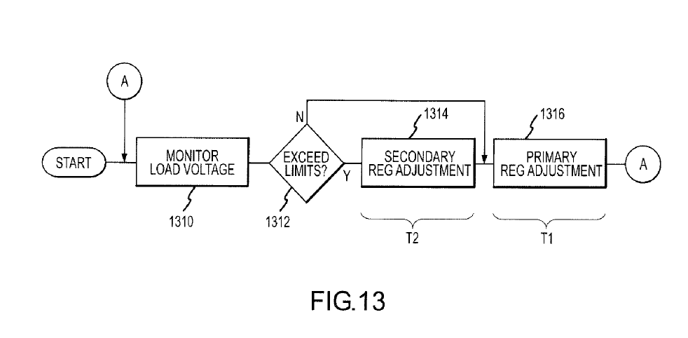

Referring to FIG. 13, the electronic system may control voltage transients for the load 20. For example, the load 20 voltage may be monitored, for example by the primary voltage regulator 22 and the secondary voltage regulator 10 (1310). The regulators 22, 10 compare the load voltage to one or more voltages, such as the reference voltage V_{REF} and/or the threshold voltages Δ_{b1}, Δₜ₁. If the load voltage exceeds one or more threshold voltages (1312), the secondary voltage regulator 10 may adjust the current provided to the load 20 within a relatively brief response time T2 (1314), for example according to a nonlinear response with respect to the load voltage. If the load voltage fails to exceed one or more threshold voltages, the primary voltage regulator 22 may adjust the load voltage within a later time period T1 (1316). The process may then repeat to drive the load voltage towards the reference voltage.

The present invention has been described above with reference to various exemplary embodiments. However, changes and modifications may be made to the exemplary embodiments without departing from the scope of the present invention. For example, the various components may be implemented in alternate ways, such as, for example, by providing other configurations of current sources and comparators. These alternatives can be suitably selected depending upon the particular application or in consideration of any number of factors associated with the operation of the system. These and other changes or modifications are intended to be included within the scope of the present invention.

1. An electronic system configured to interface with a primary voltage regulator, comprising:
a load configured to receive supply current from the primary voltage regulator; and
a secondary voltage regulator, comprising:
a current source coupled to the load and configured to provide current to the load; and
a control circuit coupled to the current source and the load, wherein the control circuit is configured to:
determine a current demand for the load exceeding the supply current received from the primary voltage regulator; and
adjust the current provided to the load by the current source according to the current demand.

2. An electronic system according to claim 1, wherein the secondary voltage regulator is configured to respond to a change in the current demand faster than the primary voltage regulator.

3. An electronic system according to claim 1, wherein the secondary voltage regulator is configured to adjust the current provided to the load according to a nonlinear relationship with the current demand.

4. An electronic system according to claim 1, wherein the secondary voltage regulator is configured to adjust the current provided to the load according to a magnitude of a change in the current demand.

5. An electronic system according to claim 1, wherein the control circuit is configured to compare the current demand to a preselected threshold and adjust the current provided to the load according to the comparison.

6. An electronic system according to claim 5, wherein the control circuit is configured to:
compare the current demand to a first preselected threshold and a second preselected threshold, wherein the first threshold and second threshold have different magnitudes with respect to a target voltage;
adjust the current provided to the load according to the comparison to the thresholds.

7. An electronic system according to claim 1, wherein:
the load and the secondary voltage regulator are disposed in a single electronic package; and
the secondary voltage regulator is coupled directly to the load.

8. A supplemental voltage regulator for providing supplemental current to a load configured to receive primary current from a primary voltage regulator, the supplemental voltage regulator comprising:
a control circuit responsive to a load voltage provided to the load by the primary voltage regulator; and
a current source responsive to the control circuit, wherein the current source is configured to provide a supplemental current to the load when the load voltage exceeds a threshold.

9. A supplemental voltage regulator according to claim 8, wherein the supplemental voltage regulator is configured to respond to a change in the load voltage faster than the primary voltage regulator.

10. A supplemental voltage regulator according to claim 8, wherein the supplemental voltage regulator is configured to adjust the current provided to the load according to a nonlinear relationship with the load voltage.

11. A supplemental voltage regulator according to claim 8, wherein the supplemental voltage regulator is configured to adjust the current provided to the load according to a magnitude of a change in the load voltage.

12. A supplemental voltage regulator according to claim 8, wherein the control circuit is configured to compare the load voltage to a preselected threshold and adjust the current provided to the load according to the comparison.

13. A supplemental voltage regulator according to claim 12, wherein the control circuit is configured to:
compare the load voltage to a first preselected threshold and a second preselected threshold, wherein the first threshold and second threshold have different magnitudes with respect to a target voltage;
adjust the current provided to the load according to the comparison to the thresholds.

14. A supplemental voltage regulator according to claim 8, wherein:
the load and the supplemental voltage regulator are disposed in a single electronic package; and
the supplemental voltage regulator is coupled directly to the load.

15. An apparatus, comprising:
a processor in a processor package; and
a current controlled transient regulator (CCTR) in the processor package and coupled to the processor.

16. An apparatus according to claim 15, further comprising a decoupling capacitor coupled to a common connection between the processor and the CCTR.

17. An apparatus according to claim 15, further comprising:
a mounting substrate, wherein the processor package is coupled to the mounting substrate;
a power socket between the processor and the mounting substrate; and
a DC power converter voltage regulator on the mounting substrate and coupled to the processor in series with the CCTR.

18. An apparatus according to claim 15, wherein the CCTR comprises:
a first controlled current source for controlling positive transients; and
a second controlled current source for controlling negative transients.

19. A method of controlling voltage transients for a dynamic load, comprising:
monitoring a load voltage at the load;
comparing the load voltage to a threshold;
within a first time period, adjusting the current provided by a first voltage regulator to make the load voltage approach a target voltage if the load voltage does not cross the threshold; and
within a second time period, adjusting the current provided by a second voltage regulator to make the load voltage approach the target voltage if the load voltage crosses the threshold.

20. A method of controlling voltage transients according to claim 19, wherein the second time period precedes the first time period.

21. A method of controlling voltage transients according to claim 19, adjusting the current provided by the second voltage regulator comprises adjusting the current provided by the second voltage regulator according to a nonlinear response with respect to the load voltage.

22. A method of controlling voltage transients according to claim 19, wherein the secondary voltage regulator and the load are disposed in a single package.
